(19) United States
(12) Patent Application Publication
(10) Pub. No.: US 2010/0312603 A1
(43) Pub. Date: Dec. 9, 2010

(54) METHOD AND SYSTEM FOR FINANCIAL PLANNING LEAD MANAGEMENT

(75) Inventors: William Theodore OVERMAN, Carlsbad, CA (US); James Lee Hardeman, Carlsbad, CA (US)

Correspondence Address: SUGHRUE MION, PLLC, 2100 PENNSYLVANIA AVENUE, N.W., SUITE 800, WASHINGTON, DC, 20037, US

(73) Assignee: EMERGING INFORMATION SYSTEMS, INC., Winnipeg (CA)

(21) Appl. No.: 12/478,099

(22) Filed: Jun. 4, 2009

(51) Int. Cl. G06Q 40/00; G06Q 10/00

(52) U.S. Cl. 705/9; 705/10; 705/35

(57) ABSTRACT

A method and system for financial planning lead management is provided. Customer inputs provided by a customer via a customer interface are received. The customer is presented with a financial plan based on the customer inputs. The customer inputs are communicated to a lead management tool executing on a server for assignment of the customer to a financial advisor.

### FIELD OF THE INVENTION

The present invention relates generally to financial services. More specifically, the present invention relates to a method and system for financial planning lead management.

### BACKGROUND OF THE INVENTION

Financial planning web sites are known. Such web sites are typically operated by financial services firms and provide potential customers with some rudimentary tools for performing basic financial planning after inputting some data, such as age and annual salary, and parameters, such as, for example, desired retirement age and desired retirement income. The term “financial plan”, as used herein, means the analysis and/or projection of one or more aspects of a customer's finances. Further, the term “customer”, as used herein, includes both potential and existing clients of a financial services provider or any person that uses the financial planning web site.

These financial planning web sites are generally powered by one or more simplified financial planning calculators, or set of financial plan logic, that is non-complex and responsive. Once the customer is presented with the calculated results, he can print out a report and discuss it with a financial advisor. Many customers, however, do not have a printer readily accessible to them, or may be using a computer with a printer in a location such as at his place of employment, where he may not feel comfortable printing such reports on a shared printer.

Alternatively, some financial planning web sites permit the customer to indicate that he wishes to be followed up with, and collect contact information from the customer to enable a financial advisor to contact them. Typically, the information requested of or provided by the customer is limited to contact information and does not include the content or context of what tools were used or results generated while on the site. As a result, the customer is often put in touch with a financial advisor that may not best suit his needs.

In some cases, a customer services representative or person responsible for managing leads calls the potential customer, or “lead”, and has a brief conversation with them to obtain more information for the purposes of placing them with a financial advisor that suits their needs. This intermediate contact can prove bothersome to many customers. Additionally, the customer often fords himself providing the same information previously entered in the financial services web site.

Recently, at least one financial planning platform solution enables, upon a customer's request, pairing up of the customer with a customer support representative that is able to view the same screen information as the customer to answer any questions the customer may have regarding the simplistic functionality available through the financial planning web site. These solutions do not, however, contemplate how to better match a customer with a financial advisor.

Once the customer is placed with a financial advisor, the customer is asked to provide the same information and parameters that he entered on the financial planning web site. If the customer had printed the financial plans prepared for him by the financial planning web site, and if the printed financial plans include the same information that the customer entered on the financial planning web site, the financial advisor can re-enter the information for the customer.

Where this is not the case, the customer is required to provide the same information and parameters again to the financial advisor, who can re-enter the information for the customer.

It is an object of the invention to provide a novel method and system for financial planning lead management.

### SUMMARY OF THE INVENTION

In accordance with an aspect of the invention, there is provided a method for financial planning lead management, comprising:

receiving customer inputs provided by a customer via a customer interface;

presenting said customer with a financial plan based on said customer inputs; and

communicating said customer inputs to a lead management tool executing on a server for assignment of said customer to a financial advisor.

The customer inputs can be presented to a lead manager via the lead management tool.

The financial plan can be presented to a lead manager via the lead management tool.

The customer inputs can be processed via the lead management tool before the presenting of the financial plan.

The processing can include identifying at least one key factor characterizing the needs of the customer.

The processing can include selecting a subset of a plurality of financial advisors for the customer.

The customer inputs can include customer data, parameters and/or economic assumptions.

The customer inputs and/or financial plan can be stored in a database.

Customer interface interaction data can be registered by the customer interface. The customer interface interaction data can be stored in a database, and communicated to the lead management tool for selection of a financial advisor for the customer. The customer interface interaction data can be presented to the lead manager via the lead management tool, and/or processed via the lead management tool to identify at least one key factor characterizing the needs of the customer. The at least one key factor can be used to at least partially select a subset of a plurality of financial advisors for the customer.

The customer inputs can include customer activity with the customer interface. The customer activity can be used to select a subset of financial advisors for the customer.

In accordance with another aspect of the invention, there is provided a system for financial planning lead management, comprising:

a customer interface for performing financial planning, said customer interface enabling a customer to provide customer inputs for generating a financial plan;

a lead management tool executing on a server for assignment of said customer to a financial advisor; and

a data exchange interface for communicating said customer inputs and said financial plan to said lead management interface. The lead management tool can present the customer inputs and the financial plan to a lead manager.

The lead management tool can process the customer inputs to identify at least one key factor characterizing the needs of the customer. The lead management tool can select a subset of a plurality of financial advisors for the customer. The subset of financial advisors is selected at least partially based on customer activity with the customer interface.

The system can further include a database for storing the user inputs and the financial plans. The financial plan is stored as a document in the database.

### BRIEF DESCRIPTION OF THE DRAWINGS

Embodiments will now be described, by way of example only, with reference to the attached Figures, wherein:

FIG. 1 shows a schematic representation of the invention in accordance with an embodiment thereof and its working environment;

FIG. 2 shows a schematic diagram of the general architecture of the system of FIG. 1;

FIG. 3 shows an example of possible workflow states during the promotion of a lead;

FIG. 4 is a flowchart of the general method of lead management using the system of FIG. 1;

FIG. 5 shows an exemplary home page of a customer interface of the system of FIG. 1 for a customer;

FIG. 6 shows a retirement assessment introduction web page navigated to from the home page of FIG. 5;

FIG. 7 shows a first customer input page of the customer interface of the system of FIG. 1 for collecting data from a customer;

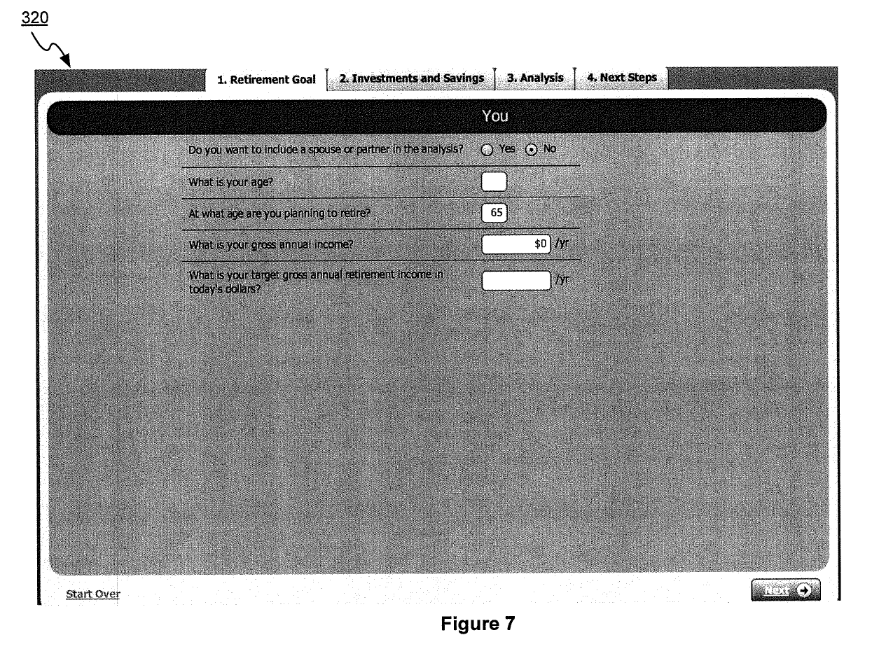

FIG. 8 shows a variation of the first customer input page of FIG. 7 for spousal data;

FIG. 9 shows a second customer input page of the customer interface of the system of FIG. 1;

FIG. 10 shows an initial financial plan page of the customer interface of the system of FIG. 1;

FIG. 11 shows the initial financial plan page of FIG. 10 with a slide-out section;

FIG. 12 shows a goal achievement method selection page of the customer interface of the system of FIG. 1;

FIG. 13 shows the initial financial plan page of FIG. 11 after goal selection;

FIG. 14 shows the initial financial plan page of FIG. 13, with additional parameters exposed;

FIG. 15 shows a “Next Steps” page of the customer interface of the system of FIG. 1;

FIG. 16 shows an exemplary report page illustrating financial plans prepared via the customer interface of the system of FIG. 1;

FIG. 17 shows an information page printed with the report page of FIG. 16;

FIG. 18 shows a data summary page that is printed with the report page of FIG. 16;

FIG. 19 shows a contact information page of the customer interface of the system of FIG. 1;

FIG. 20 shows a lead management control panel of the lead management tool of the system of FIG. 1;

FIG. 21 shows a portion of the lead management control panel of FIG. 20 during checking of a lead;

FIG. 22 shows a portion of the lead management control panel of FIG. 20 during selection of a financial advisor;

FIG. 23 shows a lead assignment comment window of the lead management control panel of FIG. 20;

FIG. 24 shows the lead management control panel of FIG. 22 after assignment of the lead;

FIG. 25 shows a lead management window presented to a financial advisor by the lead management control panel of FIG. 20;

FIG. 26 shows a portion of the lead management control panel of FIG. 25;

FIG. 27 shows a personal contact information page of the financial advisor interface of the system of FIG. 1;

FIG. 28 shows a first personal income page of the financial advisor interface of FIG. 27;

FIG. 29 shows a second personal income page of the financial advisor interface of FIG. 27;

FIG. 30 shows an assets summary page of the financial advisor interface of FIG. 27;

FIG. 31 shows a retirement scenario details page of the financial advisor interface of FIG. 27;

FIG. 32 shows a cover page of a revised report generated by the system of FIG. 1; and

FIG. 33 shows another page of the revised report of FIG. 32 showing two financial plans.

### DETAILED DESCRIPTION OF THE EMBODIMENTS

The invention relates to a method and system for financial planning lead management. The customer data and parameters entered by the customer using a financial planning web site are used to determine how to best suit the needs of a customer, such as, for example, determining which financial advisor is best suited to address the needs and/or desires of the customer. In order to achieve this, the customer data and parameters may be passed on to a lead manager, along with any financial plans prepared by the financial planning web site for the customer.

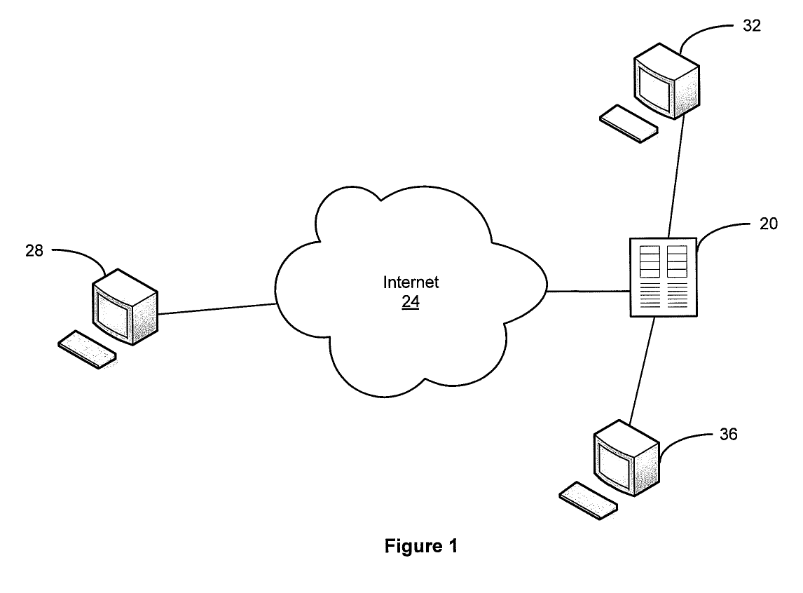

FIG. 1 is a high-level architectural diagram of a financial planning system 20 operated by a financial services firm and its working environment, in accordance with an embodiment of the invention. The financial planning system 20 manages the financial planning and advice delivery process for the financial services firm. The financial planning system 20 is coupled to the Internet 24 and can be one or more server computers (or, more simply, “servers”) acting cooperatively to provide the desired functionality. Where there is more than one server in the financial planning system 20, they can be proximate to one another or can be distributed across two or more locations. It is contemplated that each server can be one or more computers that cooperatively provide some functionality.

A customer can randomly access the financial planning system 20 using, for example, a personal computer (“PC”) 28 that is in communication with the financial planning system 20 via the Internet 24. A lead manager and financial advisor access the financial planning system 20 via PCs 32 and 36 respectively.

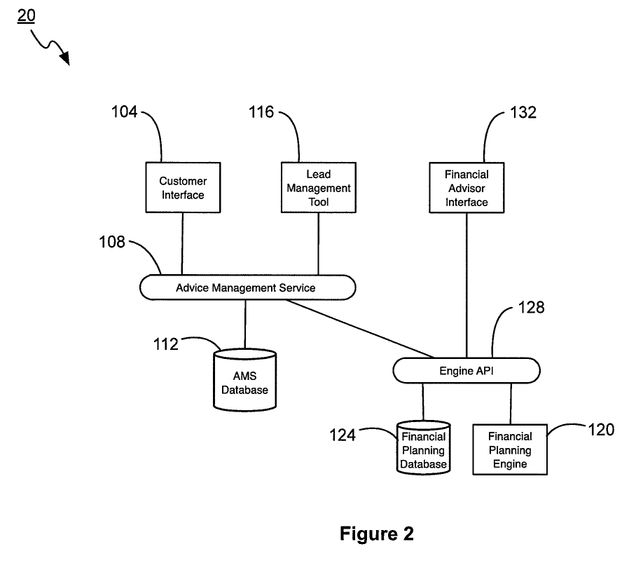

FIG. 2 shows a number of components of the financial planning system 20. A customer interface 104 provides a web interface for both client and non-client customers for providing the customer-facing functionality of the financial services web site. The customer interface 104 is in communication with an advice management service (“AMS”) 108. As the backbone of the financial planning system 20, the AMS 108 coordinates much of the functionality thereof. The AMS 108 is a data exchange interface in communication with an AMS database 112 managed by a server in the financial planning system 20 and a lead management tool (“LMT”) 116 that executes on the same or another server. Additionally, the AMS 108 is in communication with a financial planning engine 120 and a financial planning database 124 managed by a server via an engine application programming interface (“API”) 128. A financial advisor interface 132 is also in communication with the financial planning engine 120 and the financial planning database 124 via the engine API 128.

The customer interface 104 provides non-client customers the ability to enter customer data, parameters and assumptions, perform some simplified financial plans, such as “what if” analyses, create reports and, optionally, indicate that they wish to be contacted by a financial advisor for follow up. The customer data can include personal data such as name, address, age, salary, etc. Customer parameters that are used to prepare the financial plans can include the customer's target retirement age, what level of risk he is comfortable with in his financial portfolio, etc. Assumptions include the rate of return on his investments, the rate at which his salary is expected to grow, etc. The customer interface 104 also has the ability to register customer interface interaction data, such as how long a customer spent on the site or page, how many times he interacted with controls such as sliders, what kind of interaction, etc.

The AMS 108 is a web service with approximately 30 public web methods. The web methods essentially fall into two areas: the provision of an interface to the calculation and report engines of the financial planning engine 120 to handle requests and responses for calculations and report generation, and the creation, modification and retrieval of client and plan information, history, alerts, workflow status and workflow events within the financial planning engine 120. Both “areas” use a single, consolidated format for requests and responses in the form of proprietary data objects or EDS data, depending on what's appropriate for the requesting application. EDS is a proprietary data schema used for data storage and exchange throughout the financial planning system 20. It is a common format for taking in requests (read), providing responses (write) and exchanging data (future functionality). EDS has elements for client information, accounts and holdings, assets, liabilities, insurance policies, incomes, expenses, and financial planning goals (such as, for example, retirement, education, or a major purchase), planning defaults, calculated results and financial advisor information. The financial planning engine 120 and financial planning database 124 can read in EDS to create clients and plans as well as write out EDS.

The customer interface 104 sends EDS data (planning inputs) to the AMS 108, which then knows how to communicate with the financial planning engine 120 (via the engine API 128) to generate results and produce reports. When a contact form is filled out by a customer and he requests follow-up with a financial advisor, the customer data, parameters and assumptions are passed, along with the customer contact information, from the customer interface as EDS data for storage in the AMS database 112. It is stored as EDS data in the AMS database 112 until it is promoted as a client and plan in the financial planning financial planning database 124. Web methods for creating clients and plans in the financial planning database 124 are called on AMS 108 using EDS as the data input (this can be done by a custom application or using the LMT 116 as described below).

The customer interface 104 can be configured/customized to fit specific customer branding or for other goal analyses (since EDS covers more than just retirement). Additionally the architecture supports the writing of custom customer interfaces using Flash, XAML, HTML or other Rich Internet Application (“RIA”) technologies while still leveraging the full range of capabilities provided by the AMS 108, the financial planning engine 120 and the LMT 116.

The AMS 108 provides a layer of abstraction from the financial planning engine 120 so that new applications for interfacing with the financial planning engine 120 can leverage the financial planning engine, workflow functions and data stored within the financial planning engine 120 and the financial planning database 124 in a consolidated manner without having a deep knowledge of its inner workings or data format.

The LMT 116 allows for centralized or distributed review and assignment of leads collected from the customer interface 104. The LMT 116 calls the AMS 108 for a list of leads stored in the AMS database 112 that returns lead data in the EDS format. As previously described, leads can be converted to clients and plans by the AMS 108 once promoted by the LMT 116. Once a customer is promoted to become a client, the customer data, parameters and assumptions are transferred from the AMS database 112 to the financial planning database 124.

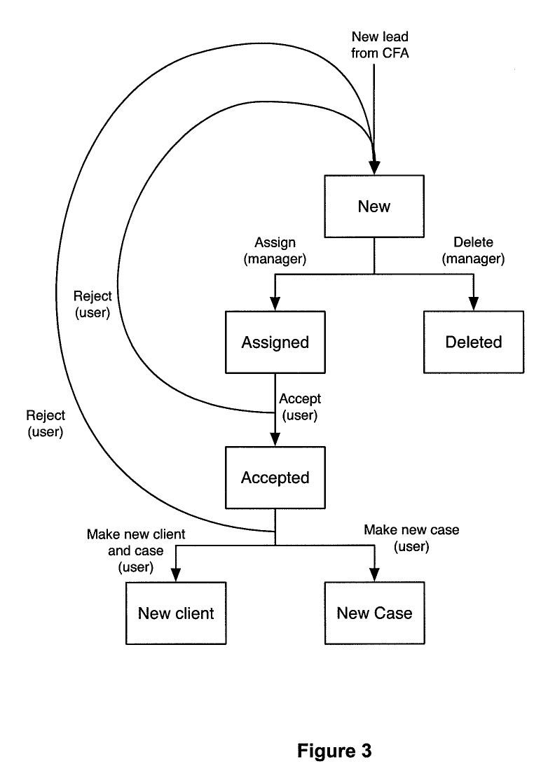

FIG. 3 shows an example of the possible workflow states (new, assigned, deleted, etc.), the possible transitions among states (the arrows), the actions that cause the transitions (assign, reject, accept, etc.), and the roles who can perform those actions (user or manager) within the process.

At the heart of the financial planning system 20 is the financial planning engine 120. The financial planning engine 120 performs and renders all financial calculations as well as assembles the financial planning reports. Where the financial planning engine 120 is generating a financial plan on behalf of one of the many user interfaces, such as the customer interface 104, the user interface can be configured to provide base data, parameters and assumptions where not provided by the user. The financial planning engine 120 is designed to use the data, parameters and assumptions provided by the interface and use default parameters and assumptions where the interface does not provide the same. While varying levels are available through the various interfaces (i.e., the customer interface 104, the LMT 116 and the financial advisor interface 132), the financial planning engine 120 leverages a single calculation and report engine to generate calculated results and financial plans.

Not only does the financial planning engine 120 generate financial plans, including various projections, but it also generates various graphs as required by the customer interface 104, along with custom reports detailing the financial plans. In order to generate these custom reports, the financial planning engine 120 is provided a library of report page templates into which details of the financial plans and graphs can be inserted. Requests for financial plans and reports from any of the interfaces 104, 116, 132 include details regarding what kind of financial plan details and graphs are expected in response, and what pagers are desired in the reports. In generating these reports, the financial planning engine 120 simply populates the selected report template pages with the financial plan calculations and graphs, as required.

The financial planning database 124 stores customer data, parameters, plan meta data, assumptions, and financial plan projection data and graphs previously generated for clients of the financial services firm.

The AMS 108 and the engine API 128 provide programming interfaces through which the financial planning engine 120 and the financial planning database 124 are accessible. The programming interfaces permit other applications to provide inputs, generate one or more financial plans using the inputs, and allows output of the financial plan(s) to the other applications. Workflow functionality for the creation, review and approval/rejection of financial plans is provided by the engine API 128 and the financial planning engine 120.

The financial advisor interface 132 communicates with the financial planning engine 120 and the financial planning database 124 via the engine API 128 to enable a financial advisor to input various data and assumptions, select one or more financial plan projections to run and view the executed financial plan projections. The financial advisor interface 132 is a web application that is accessible via a browser or financial advisor portal.

Just as with the customer interface 104 and the LMT 116, the calculated onscreen results and printed reports for financial advisor-facing financial advisor interface 116 are generated by the financial planning engine 120.

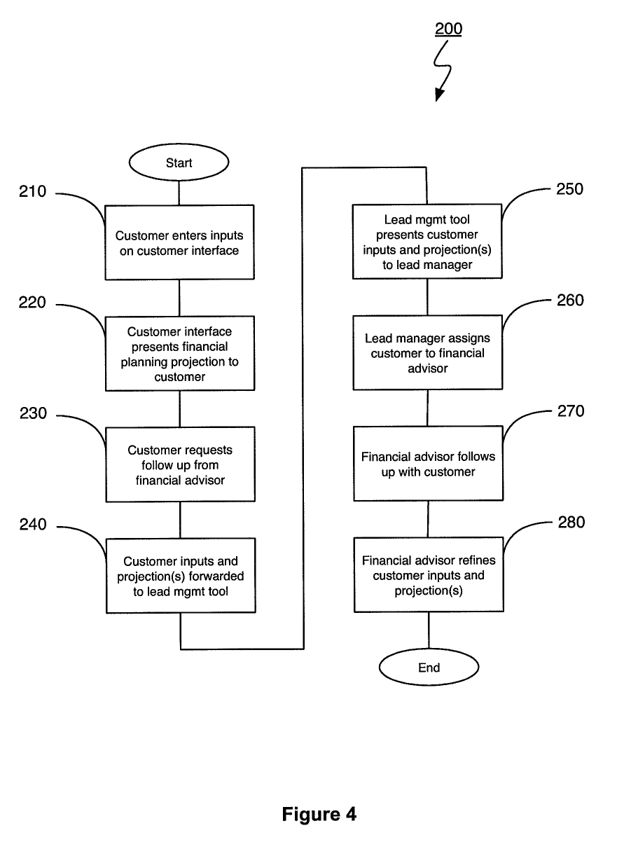

The general method 200 of financial planning lead management performed by the system 20 will now be described with reference to FIGS. 1 to 4. In order to use the financial planning system 20, a customer that is not a client of the financial services firm operating the financial planning system 20 logs onto his PC 28 and navigates to the customer interface 104 via a web browser.

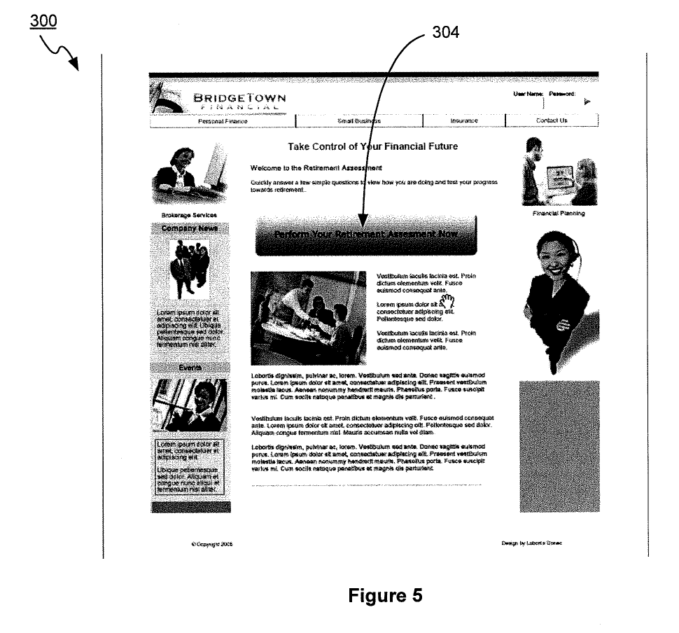

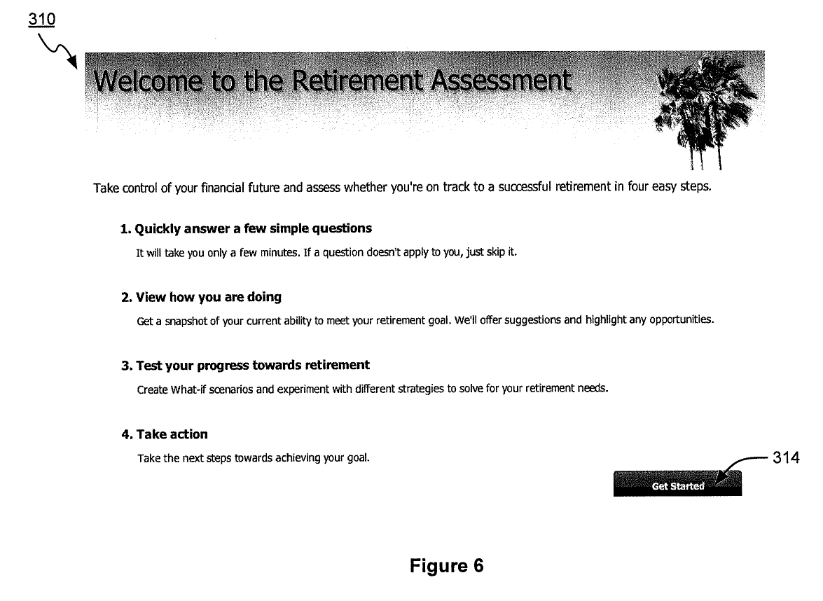

FIG. 5 shows an exemplary home page 300 presented by the customer interface 104 for a financial services firm that is presented to a customer upon navigating to the financial services firm's website. Activation of a button 304, by mousing over it and clicking it, causes the customer's PC 28 to be presented with a retirement assessment introduction web page 310, as shown in FIG. 6. The retirement assessment introduction web page 310 provides a list of steps that can be followed to put together a financial plan. The steps are: (a) provide customer data and parameters; (b) view a financial plan based on the information provided in (a); (c) perform “what-if” projections to understand how the customer's financial plan from (b) can be altered; and (d) contact a financial advisor.

The customer selects to generate a financial plan and is presented with to a series of web pages by the customer interface 104 that enable the customer to enter in customer inputs (step 210). Activation of a button 314 labeled “Get Started” on the retirement assessment introduction web page 310 causes the customer interface to present a first customer input page 320, as shown in FIG. 3, where the customer is asked to provide customer data, such as his age and salary, and some parameters, such as when he plans to retire and what his target retirement income is.

The term “customer inputs”, as used herein, includes, but is not limited to, customer data, such as age, salary, and contact information, and customer parameters, such as target retirement age, target retirement income, etc. Additionally, any assumptions provided by the customer can also be classified as “customer inputs”.

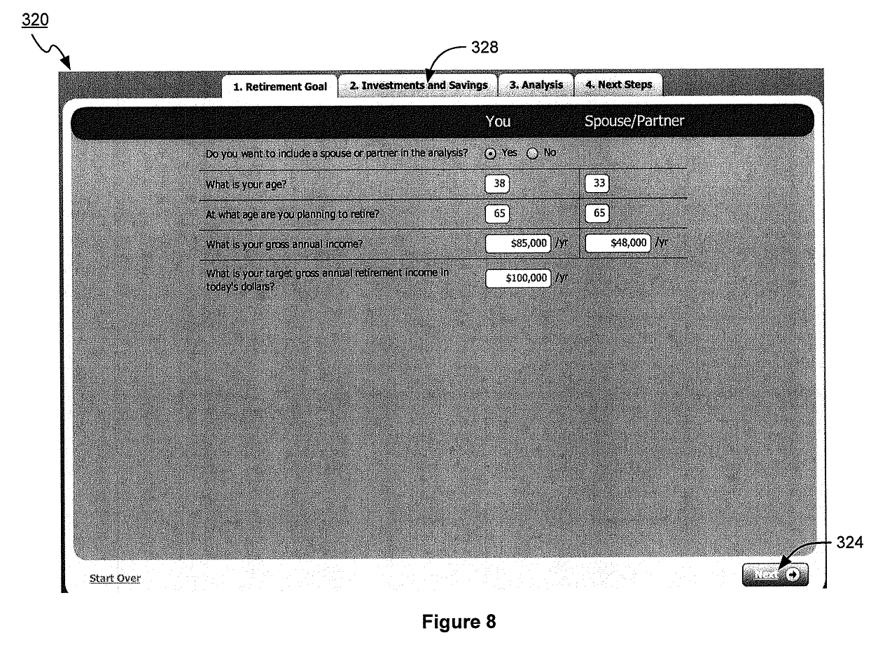

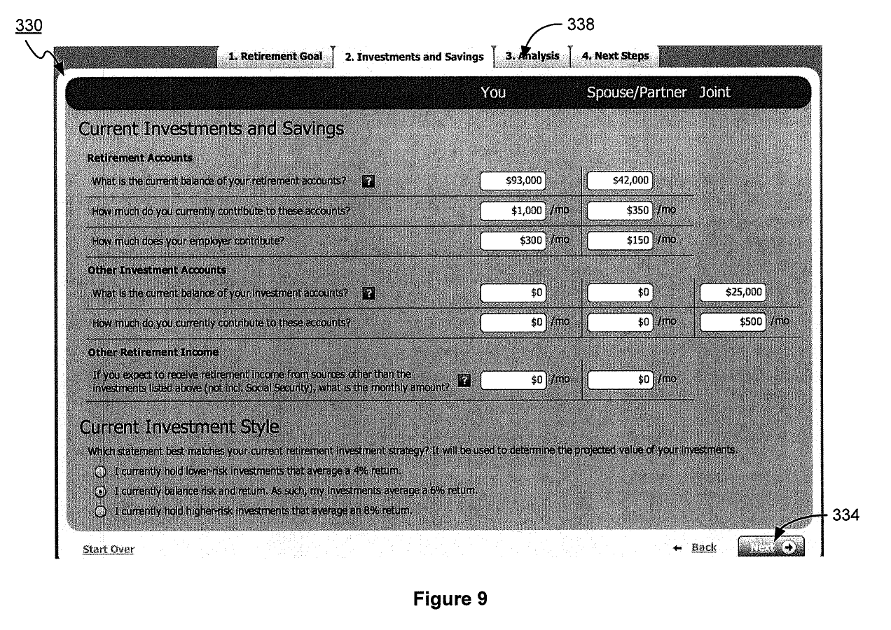

FIG. 8 illustrates the first customer input page 320 when an option to include a spouse in the financial plan is selected. In this case, the first customer data page 320 presents additional entry boxes for the spousal information. Activation of a “Next” button 324 or a second tab 328 at the top of the screen takes the customer to a second customer input page 330, as shown in FIG. 9. The second customer input page 330 presents a number of places where the customer can enter information regarding his assets.

All of the customer inputs collected by the first and second customer input pages 320, 330 are temporarily stored, along with any customer interface interaction data, in memory by the customer interface 104 in association with the web session between the customer's PC 28 and the customer interface 104.

Upon activation of a “next” button or a third tab 338, the customer interface 104 sends a request for the financial plan to the financial planning engine 120 via the AMS 108 and the engine API 128. The customer inputs collected and temporarily stored by the customer interface 104 are passed along with the request, together with specifications of what graphs and report template pages are required. The financial planning engine 120 receives the customer inputs accompanying the request, uses default assumptions where information has not been provided by the customer interface 104 and generates a financial plan. The financial plan is then returned to the customer interface 104 for presentation to the customer (step 220). The financial planning engine 120 generates any required graphs and returns them, along with the financial plan calculations.

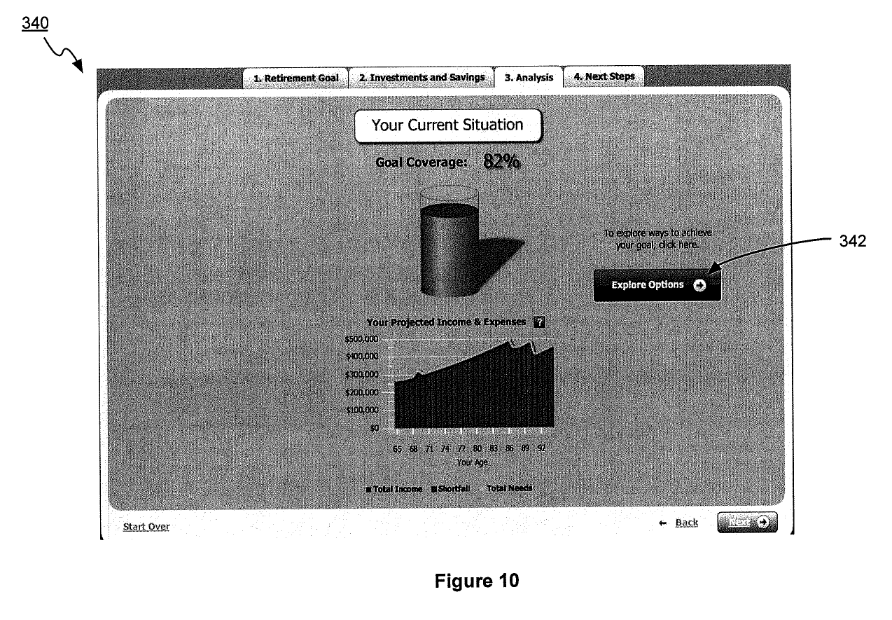

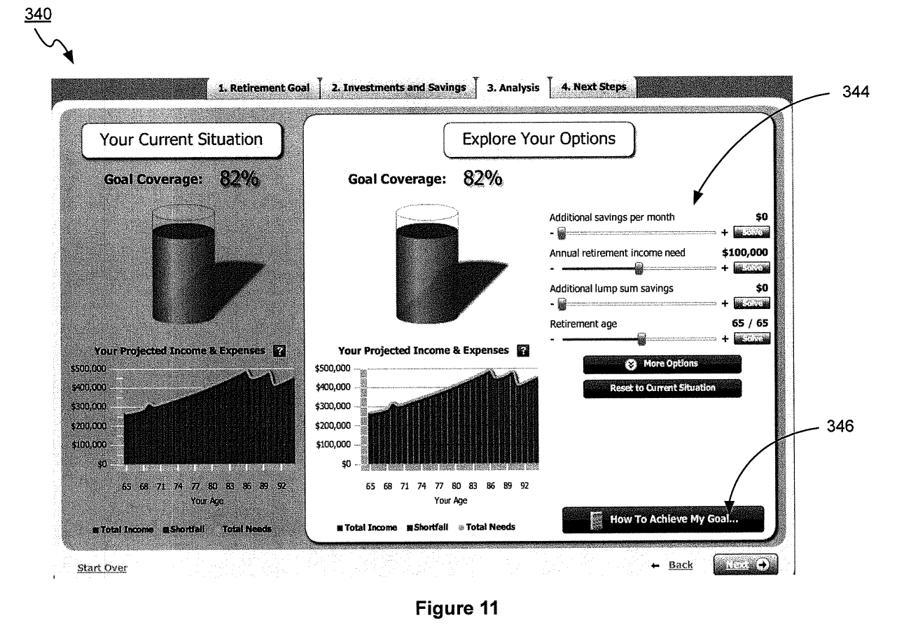

FIG. 10 shows an initial financial plan page 340 in which the customer is presented with his current financial outlook for retirement, and is notified of how much his retirement savings in this projection fall short of his retirement income goal, if at all. Activation of an “Explore Options” button 342 enables the customer to perform some additional financial plans via a slide-out section, as shown in FIG. 11. As shown, the customer's current financial plan slides to the left and the customer can then alter his parameters by manipulation of a set of controls 344 on the right side of the screen. All of the customer's interaction with the page is registered as customer interface interaction data.

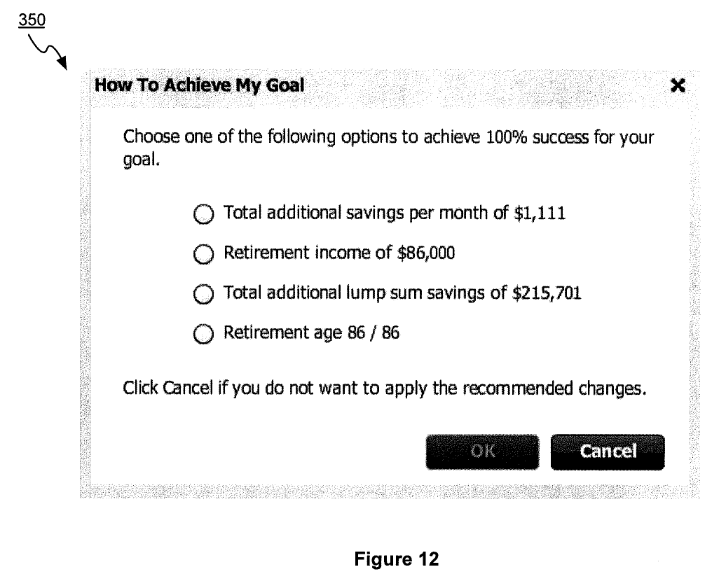

Activation of a button 346 labeled “How To Achieve My Goal” takes the customer to a goal achievement method selection page 350, as shown in FIG. 12. On the goal achievement method selection page 350, the customer is presented with a number of variations to his parameters to assist him in meeting his retirement targets. As shown, the options include: (a) additional monthly savings; (b) a change to the target retirement income; (c) an additional target lump sum savings desired at retirement; and (d) a change to the target retirement age. As will be appreciated, these all represent modifications to the customer's parameters.

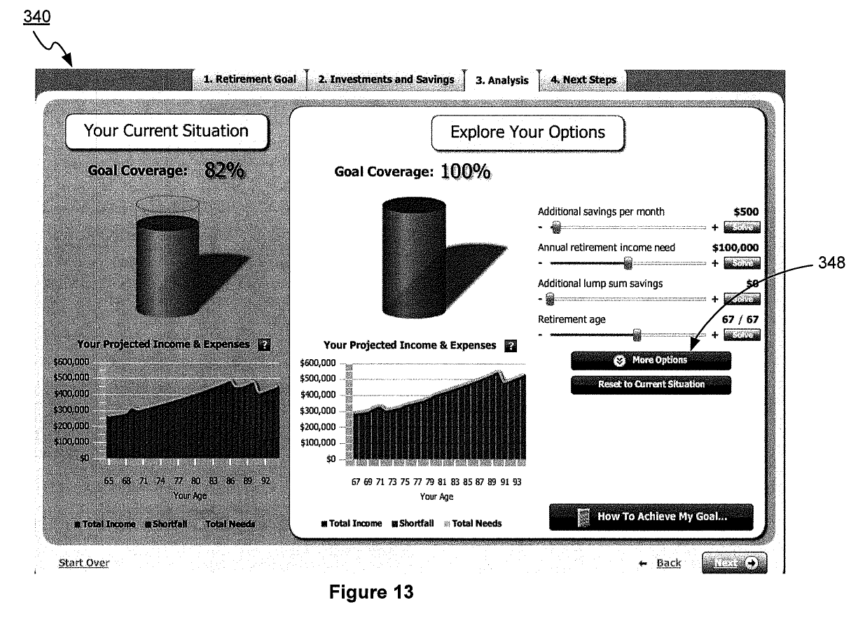

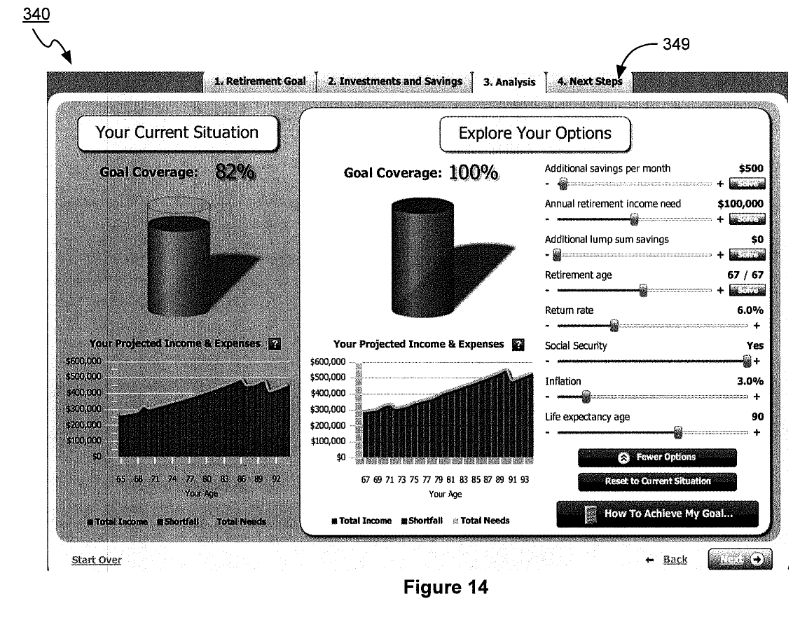

FIG. 13 shows the initial financial plan page 340 to which the customer is returned after selecting an option on the goal achievement method selection page 350. As shown, the initial financial plan page 340 has been modified in response to the customer's change in parameters. Activation of a “More Options” button 348 exposes controls to change additional parameters, as shown in FIG. 14.

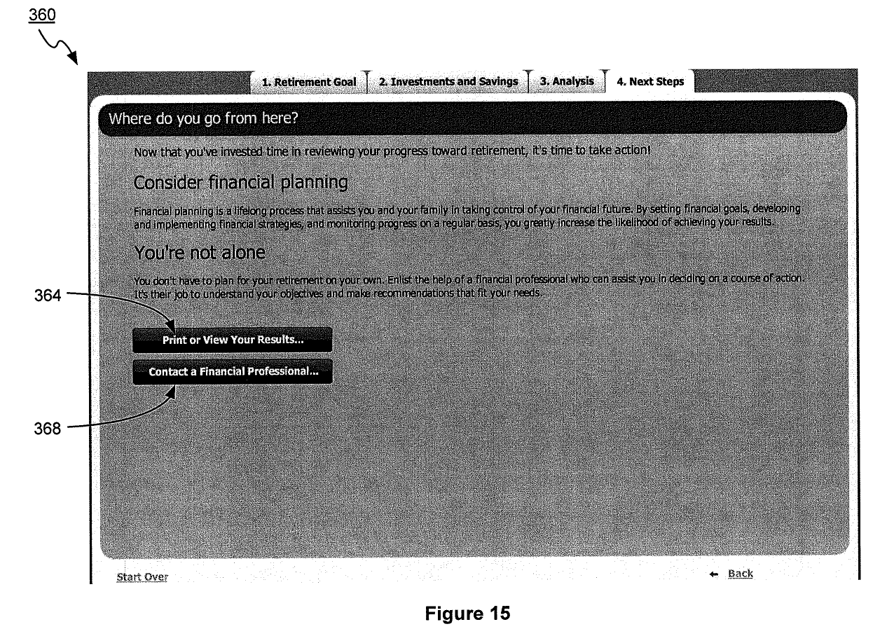

Activation of a fourth tab 349 at the top of the initial financial plan page 340 takes the customer to a “Next Steps” page 360, as shown in FIG. 15. This page presents a print button 364 to print the prepared financial plan, and a follow-up button 368 that, if activated, indicates that the customer wishes follow-up from a financial advisor. If the customer activates the print button 364, the customer interface 104 sends a request to the financial planning engine 120 for a report, along with the same customer inputs used to generate the financial plan. In response, the financial planning engine 120 regenerates the financial plan and then generates a report with the specified pages and returns it to the customer interface 104.

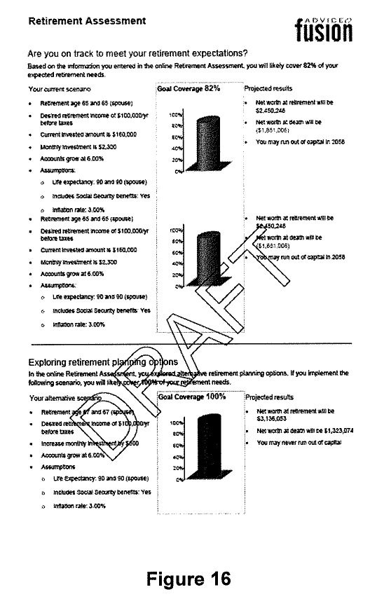

FIG. 16 presents an exemplary printout illustrating financial plans for both the current basis and for the modified basis.

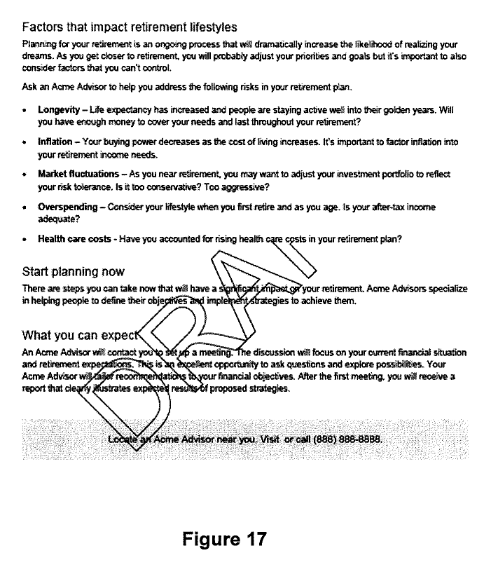

FIG. 17 shows an information sheet that is printed with the financial plans. The information sheet explains the effect of some factors that affect the financial plans.

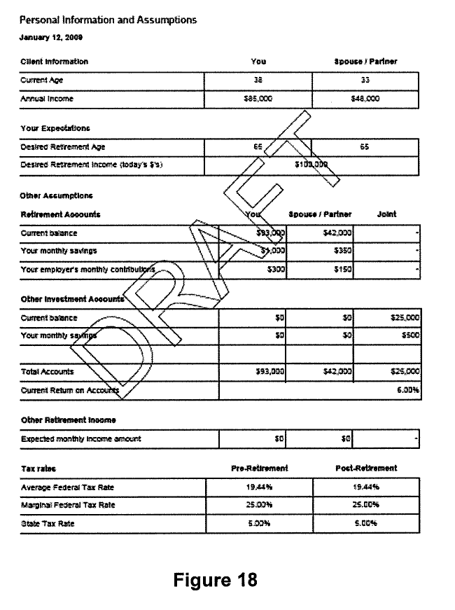

FIG. 18 shows a data summary sheet that is also printed with the financial plans. The data summary sheet summarizes the customer data and parameters, and the economic assumptions used as a basis for the financial plans.

At this time, the customer can request follow-up from a financial advisor by clicking on the follow-up button 368 on the “Next Steps” page 360 of the customer interface 104 (step 230).

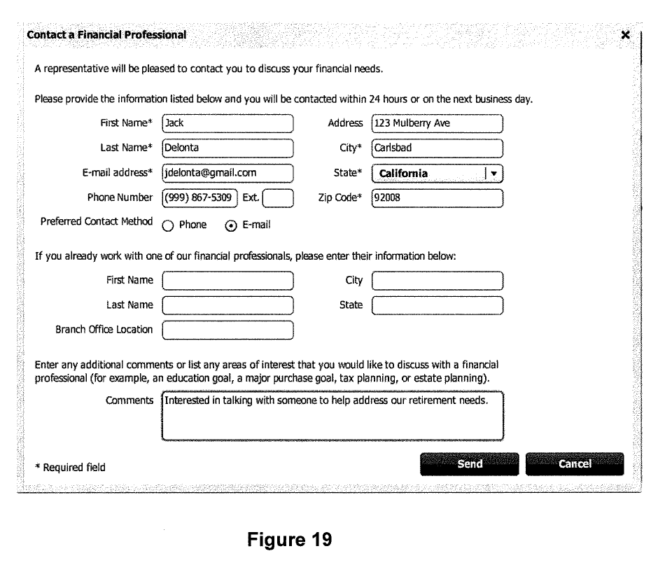

FIG. 19 shows a contact information page that the customer is presented with upon activating the follow-up button 368 on the “Next Steps” page 360. Upon providing contact information and activating a send button on the contact information page, the customer inputs, projection(s), graphs and customer interface interaction data are then stored in the AMS database 112 and made available to the LMT 116 (step 240). As will be appreciated, only if the customer wishes to proceed are the customer inputs and customer interface interaction data “committed” to the AMS database 112 from the customer interface 104.

The LMT 116 can access the customer inputs and financial plan projection data and graphs, and present them to a lead manager (step 250). In addition, if desired, the LMT 116 can request that the financial planning engine 120 generate the report that the customer may have viewed.

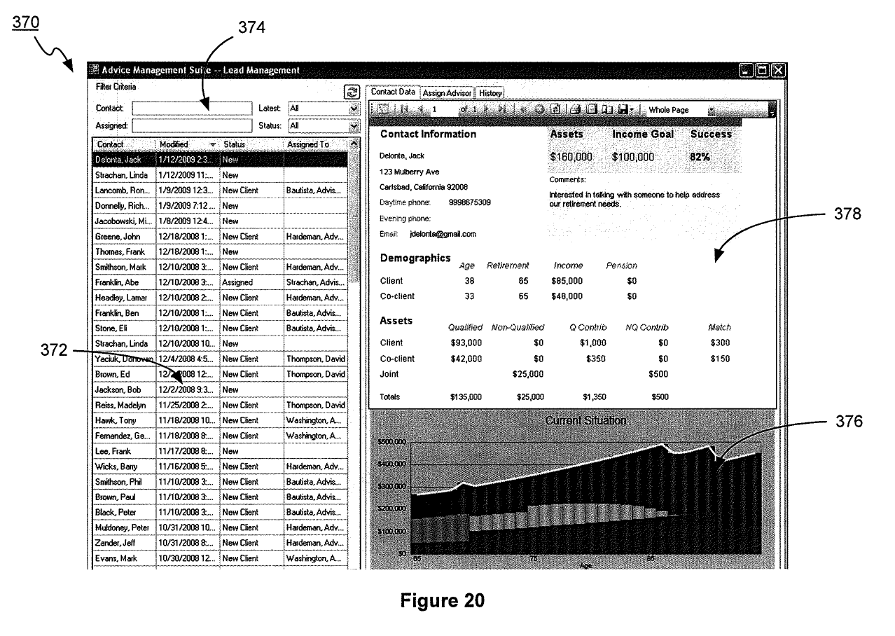

FIG. 20 shows a lead management control panel 370 of the LMT 116 that is accessible from a portal or launched from an executable on the user's desktop. The lead management control panel 370 has a lead list pane 372, a lead search pane 374, a lead graph pane 376 and a lead inputs and assumptions pane 378. The lead list pane 372 indicates the status of each lead (i.e., whether the lead has been assigned to a financial advisor or not) and the last date that the lead record was modified. The lead search pane 374 facilitates location of a lead. The lead graph pane presents a visual representation of the financial plan(s) for the lead selected in the lead list pane 372. The lead inputs and assumptions pane 378 provides a summary of all the customer inputs and assumptions used to generate financial plans for the lead.

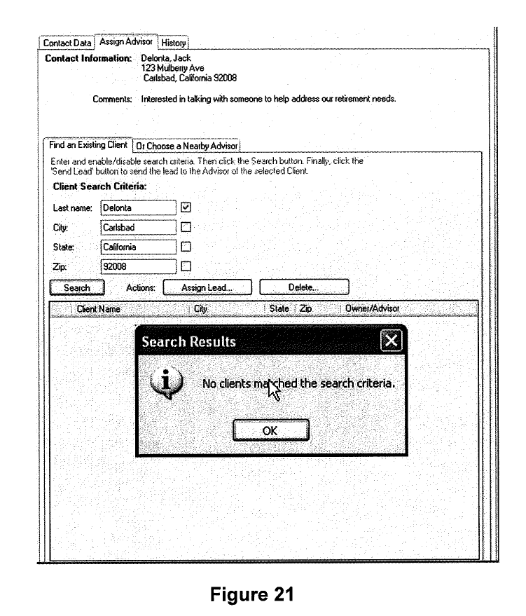

FIG. 21 shows a portion of the lead management control panel 370 wherein a lead is checked to determine if the lead is already an existing client of the financial services firm.

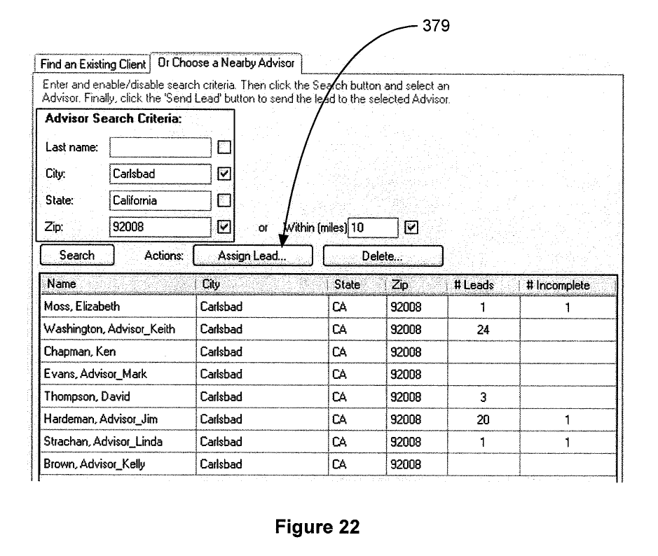

FIG. 22 shows a portion of the lead management control panel 370 wherein the LMT 116 has processed the customer inputs to determine at least one factor that characterizes the needs of the customer, and then selects a subset of all financial advisors using the key factor(s). In this case, the key factor used is location. The contact information of the lead is used to locate financial advisors proximate to the customer. An “Assign Lead” button 379 permits the lead to be assigned to a financial advisor for follow-up.

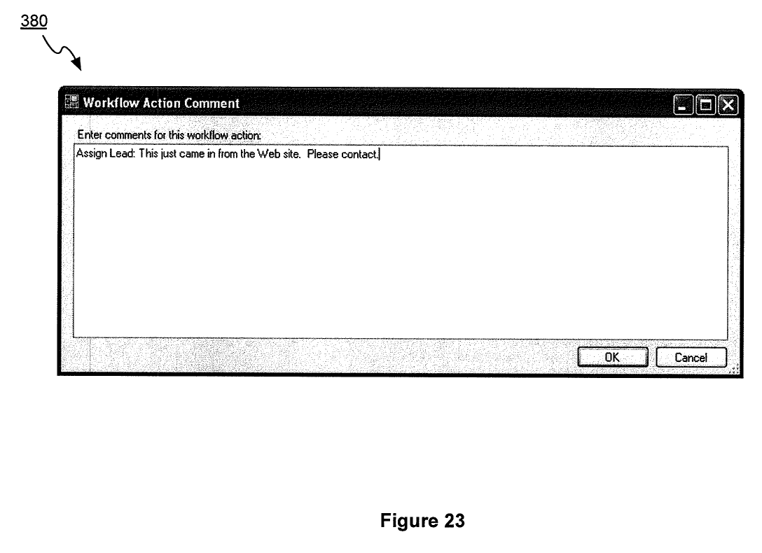

FIG. 23 shows a lead assignment comment window 380 that pops up upon activation of the “Assign Lead” button 379 of the lead management control panel 370.

Using the customer inputs and the financial plan(s) generated for a customer, the lead manager assigns a financial advisor to follow up with the customer (step 260). In addition to any processing performed by the LMT 116, the lead manager can review the customer inputs and financial plans to identify key factors that characterize the needs of the customer. Such key factors can include, but are not limited to, location, portfolio size, age of customer, years to targeted retirement age, income level, target retirement income shortfall, level of sophistication, etc. Additionally, the LMT 116 and/or the lead manager may also consider financial advisor-specific factors such as conversion rate (from leads to clients), “busyness”, etc.

Upon assignment of a customer to a financial advisor, the lead is stored in the AMS database 112 and the AMS 108 alerts the financial advisor assigned to the customer.

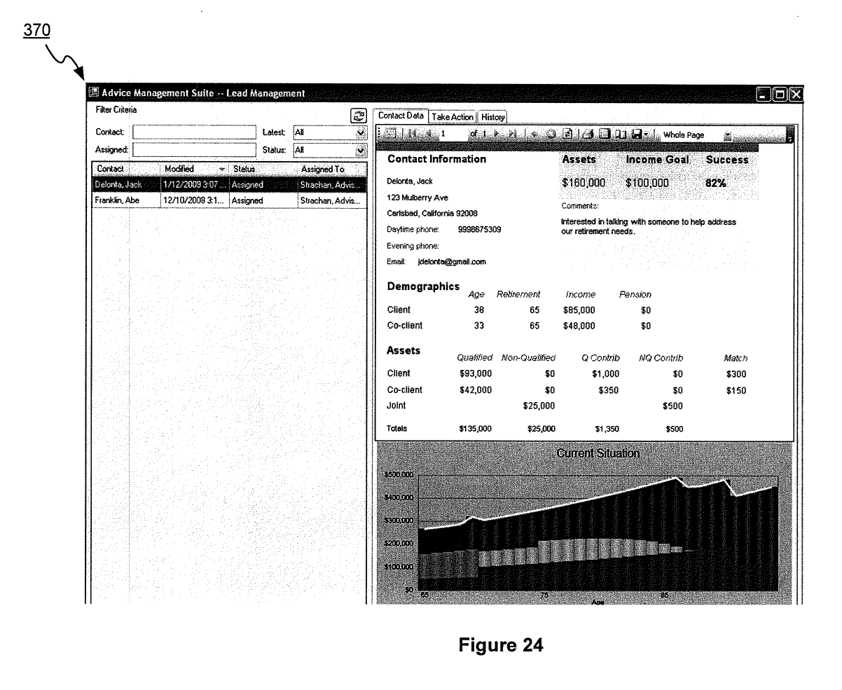

FIG. 24 shows the lead management control panel 370 once the lead is assigned to a financial advisor for follow-up.

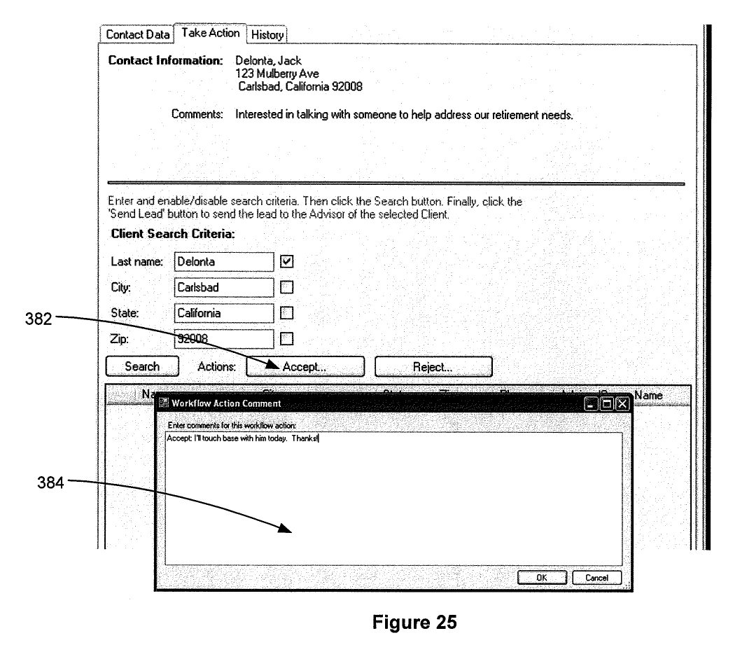

FIG. 25 shows a portion of the lead management control panel presented to a financial advisor by the LMT 116 after assignment of the lead. As shown, upon activating an “accept” button 382, a pop-up comments window permits the financial advisor to provide commentary to the lead manager.

Upon receiving the customer inputs and financial plans, the financial advisor contacts the customer (step 270). At this time, the customer can provide more detailed personal data and parameters to the financial advisor in order to refine the financial plans. The financial advisor enters in any additional customer inputs into the advisory interface to refine the financial plans previously prepared for the customer (step 280).

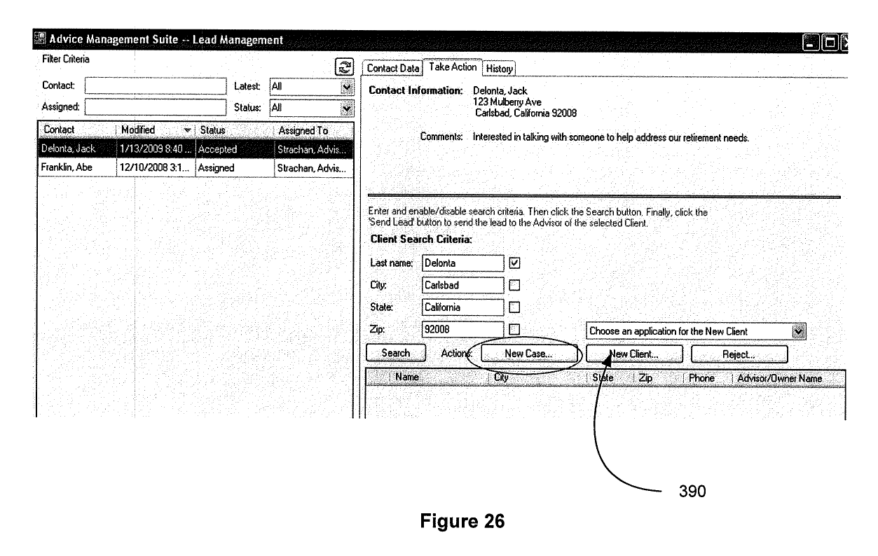

FIG. 26 shows a portion of the lead management control panel 370 as presented to the financial advisor. A “New Client” button 390 enables the financial advisor to promote the customer to become a client.

When a customer is promoted to become a client, their data stored in the AMS database 112 is transferred to the financial planning database 124 and the financial advisor can now access the customer inputs from the financial advisor interface 132.

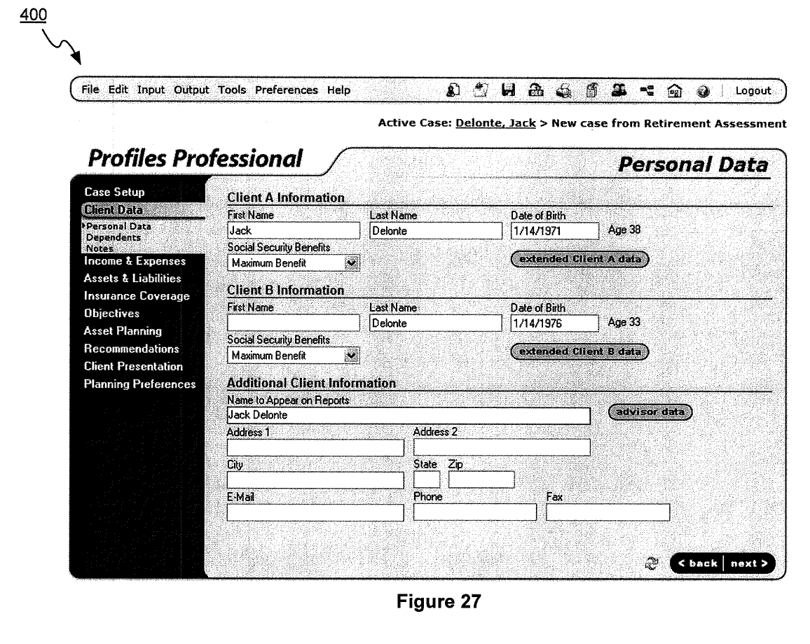

FIG. 27 illustrates a personal contact information page 400 generated by the financial advisor interface 132. As can be seen, the personal data from the AMS database 112 has been transferred to the financial planning database 124 and now populates the personal data page 400.

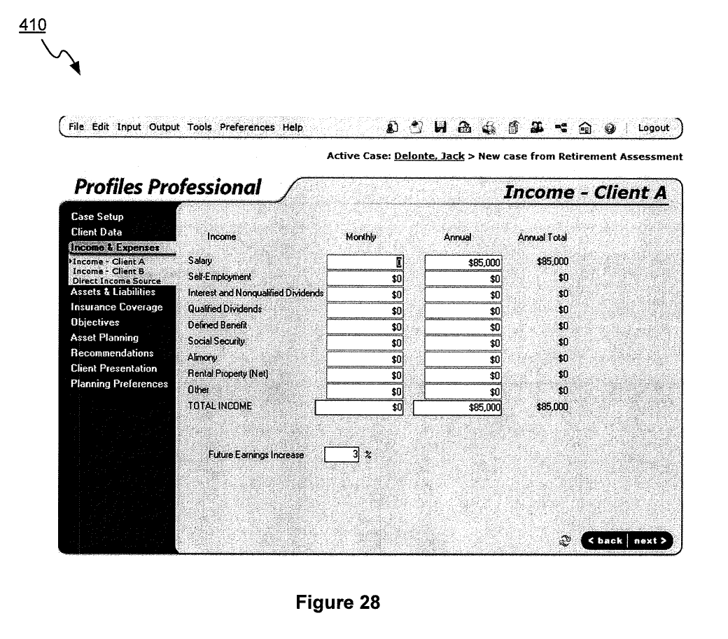

FIG. 28 shows a first personal income page 410 that is also automatically populated using the customer inputs in the financial planning database 124. In addition, the annual earnings increase rate is presented.

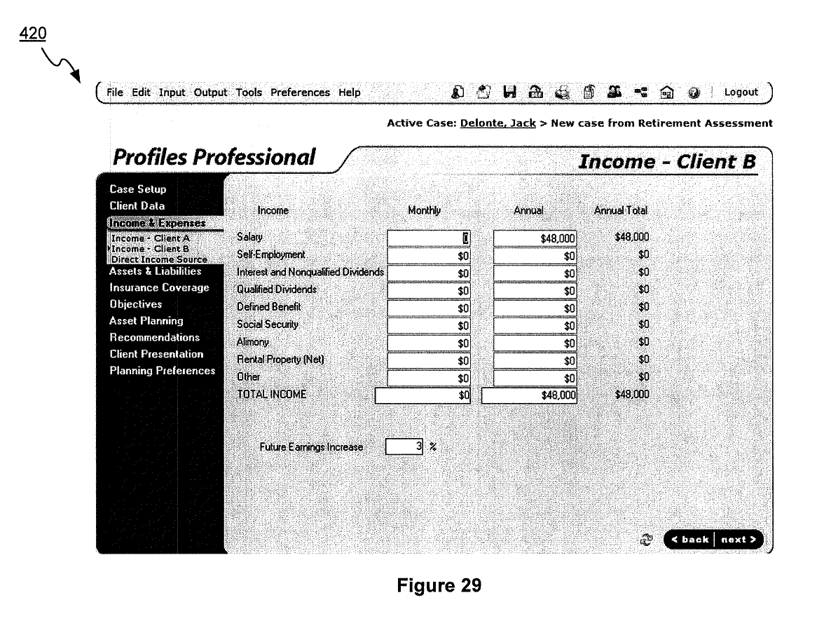

FIG. 29 shows a second personal income page 420 similar to the first personal income page 410, except that lists the personal income of the client's spouse.

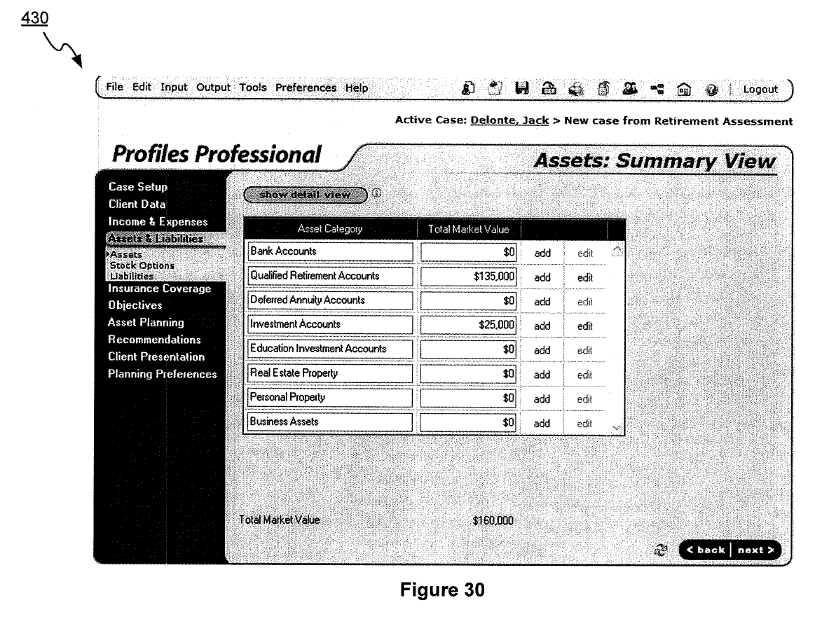

FIG. 30 shows an assets summary view 430 summarizing the assets of the customer.

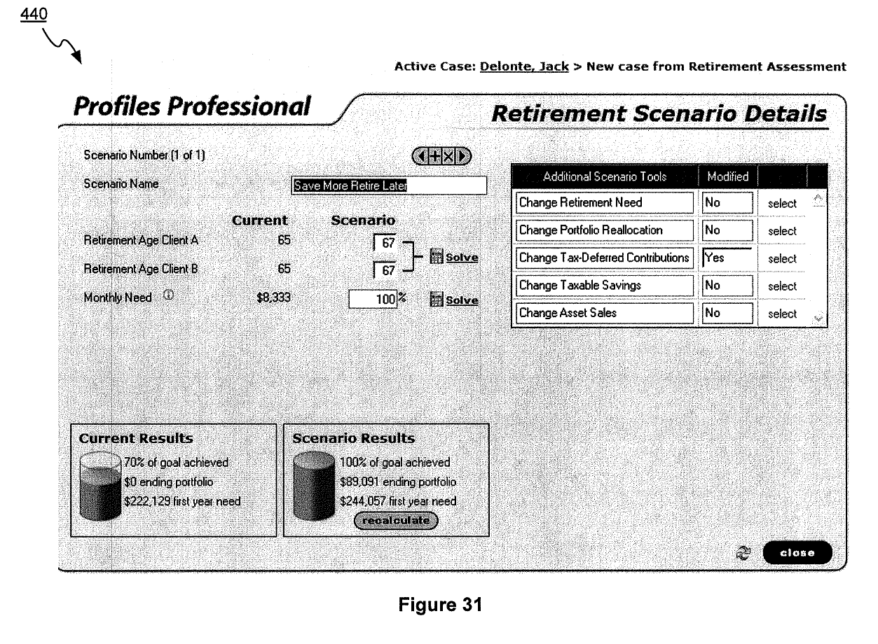

FIG. 31 shows a retirement scenario details page 440 where the financial advisor can modify the parameters for the financial plans. This is typically done with the customer present and while exploring the parameters with them.

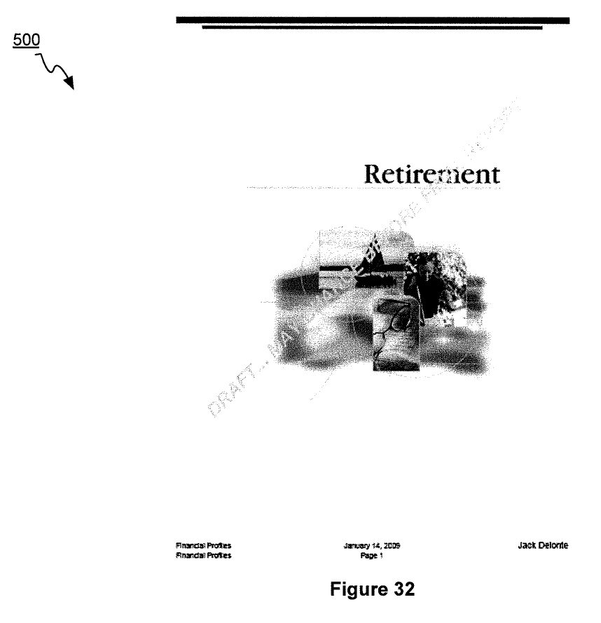

FIG. 32 shows a cover page 500 of a financial plan report that is prepared by the financial advisor.

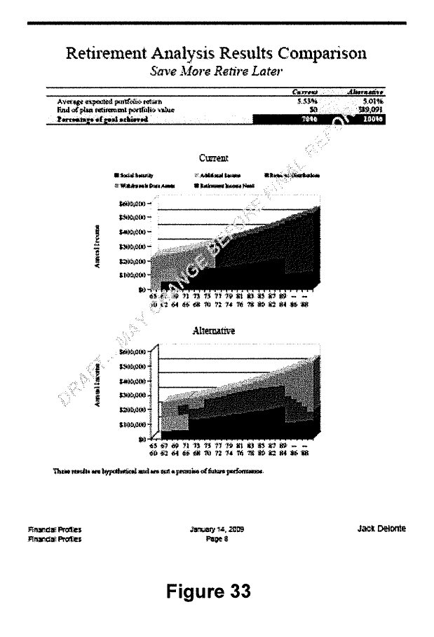

FIG. 33 shows a (vertical) side-by-side graphical comparison of the results of the initial and subsequent financial plans that forms part of the financial plan report prepared by the financial advisor.

The various interfaces can be provided with applications to which non-browser clients can connect to have the same functionality as described herein.

While, in the above-described embodiment, only customer inputs are used to select a subset of financial advisors for a customer, the customer interface interaction data can also be used in a similar manner. The customer interface interaction data can be logged and tracked statistically. Summaries of the customer's interaction can be presented to the lead manager for assisting the lead manager in selecting an appropriate financial advisor. For example, the amount of time a customer spent on each page can, by itself, be taken to indicate the amount of time and interest that the customer has for financial planning.

Additionally, the customer interface interaction data can be processed by the LMT to identify one or more key factors that can be used to select a subset of all financial advisors for the customer. As an example, where a customer spent a threshold amount of time interacting with a target retirement age slider control, the customer may benefit from being matched with a financial advisor who can present a number of flexible scenarios and has knowledge/experience with a number of different short and long-term asset classes. Customer interaction with an “annual retirement savings” slider control, wherein the customer moves the slider into (and possibly out of) a range of larger amounts, may indicate that the customer may need a financial advisor that is able to deal with more sophisticated taxation issues.

Further, trending of the customer inputs and the customer interface interaction data can reveal patterns that exist that can help to better place a customer with a financial advisor. These patterns can be, and in many cases are, non-intuitive.

While the system is described as a set of computers coupled together, those skilled in the art will appreciate that other configurations can be used without departing from the spirit of the invention. For example, a single computer could provide all of the functionality.

The above-described embodiments are intended to be examples of the present invention and alterations and modifications may be effected thereto, by those of skill in the art, without departing from the scope of the invention, which is defined solely by the claims appended hereto.

What is claimed is:

1. A method for financial planning lead management, comprising:
receiving customer inputs provided by a customer via a customer interface;
presenting said customer with a financial plan based on said customer inputs; and
communicating said customer inputs to a lead management tool executing on a server for selection of a financial advisor for said customer.

2. The method of claim 1, further comprising:
presenting said customer inputs to a lead manager via said lead management tool.

3. The method of claim 1, further comprising:
presenting said financial plan to a lead manager via said lead management tool.

4. The method of claim 1, further comprising, before said presenting said financial plan:
processing said customer inputs via said lead management tool.

5. The method of claim 4, wherein said processing comprises:
identifying at least one key factor characterizing the needs of said customer.

6. The method of claim 4, wherein said processing comprises:
selecting a subset of a plurality of financial advisors for said customer.

7. The method of claim 1, wherein said customer inputs include customer data.

8. The method of claim 1, wherein said customer inputs include customer parameters.

9. The method of claim 1, wherein said customer inputs include customer-selected economic assumptions.

10. The method of claim 1, further comprising:
storing said customer inputs in a database.

11. The method of claim 10, further comrising:
storing said financial plan in said database.

12. The method of claim 1, further comprising, before said communicating:
registering customer interface interaction data via said customer interface.

13. The method of claim 12, further comrising:
storing said customer interface interaction data in a database.

14. The method of claim 12, further comprising:
communicating said customer interface interaction data to said lead management tool for selection of a financial advisor for said customer.

15. The method of claim 14, further comprising:
presenting said customer interface interaction data to said lead manager via said lead management tool.

16. The method of claim 14, further comprising:
processing said customer interface interaction data via said lead management tool to identify at least one key factor characterizing the needs of said customer.

17. The method of claim 16, further comprising:
selecting a subset of a plurality of financial advisors for said customer at least partially based on said customer interface interaction data.

18. A system for financial planning lead management, comprising:
a customer interface for performing financial planning, said customer interface enabling a customer to provide customer inputs for generating a financial plan;
a lead management tool executing on a server for assignment of said customer to a financial advisor; and
a data exchange interface for communicating said customer inputs and said financial plan to said lead management interface.

19. The system of claim 18, wherein said lead management tool presents said customer inputs to a lead manager.

20. The system of claim 19, wherein said lead management tool additionally presents said financial plan to said lead manager.

21. The system of claim 18, wherein said lead management tool processes said customer inputs to identify at least one key factor characterizing the needs of said customer.

22. The system of claim 21, wherein said lead management tool selects a subset of a plurality of financial advisors for said customer.

23. The system of claim 18, further comprising:
a database for storing said user inputs.

24. The system of claim 23, wherein said financial plan is stored in said database.

25. The system of claim 24, wherein said financial plan is stored as a document in said database.

26. The system of claim 22, wherein said subset of financial advisors is selected at least partially based on customer activity with said customer interface.
